(19) United States
(12) Patent Application Publication
(10) Pub. No.: US 2017/0008430 A1
(43) Pub. Date: Jan. 12, 2017

(54) OPERATOR SEAT ADJUSTMENT SYSTEM

(71) Applicant: Caterpillar Inc., Peoria, IL (US)

(72) Inventor: Sean A. Randleman, East Peoria, IL (US)

(73) Assignee: Caterpillar Inc., Peoria, IL (US)

(21) Appl. No.: 15/271,568

(22) Filed: Sep. 21, 2016

(51) Int. Cl. B60N 2/44; B60N 2/38

(52) U.S. Cl. CPC B60N 2/4415; B60N 2/38; B60N 2/4492

(57) ABSTRACT

A seat adjustment system for an operator seat is provided. The seat adjustment system includes a base support and at least two supports which are disposed laterally to the base support. The at least two supports have a plurality of bolsters. The bolsters are positioned on an inner surface of an operator console. The at least two supports define an operator seating space therebetween having a fixed maximum capacity. An adjustment module is operatively coupled with the bolsters. The adjustment module is adapted to selectively inflate the bolsters for decreasing the operator seating space with respect to the fixed maximum capacity. The adjustment module is adapted to selectively deflate the bolsters for increasing the operator seating space with respect to the fixed maximum capacity. The adjustment module is adapted to alter a current operator seating capacity with respect to the fixed maximum capacity based on an operator input.

### TECHNICAL FIELD

The present disclosure relates to a seat adjustment system, and more specifically, to the seat adjustment system for an operator seat.

### BACKGROUND

Machines, such as hydraulic excavators, bulldozers, or dump trucks, are used for performing various operations. Typically, the machines include an operator cabin which has multiple controls for operating the machine. The operator cabin includes a seat in which an operator sits and operates the machine. During the operation of the machine on a variety of terrains, such as sand surfaces, mud surfaces, grades, side slopes, or any other uneven surfaces, the operator may face trouble in maintaining an optimal position in the seat.

Currently, the seat is designed to accommodate a wide range of operator sizes. However, during the operation of the machine, some of the operators may not be in a comfortable position on the seat. For example, the operator who is lean may have trouble maintaining the optimal position on the seat, if there is too much free space in the seat. Further, due to the free space in the seat, the operator may be pushed from one side to another in the seat while the machine moves on the variety of the terrains. Therefore, the comfort level of the operator may be affected, resulting in decreased productivity.

U.S. Pat. No. 5,975,629 describes a vehicle seat with an inflatable bladder. The vehicle seat includes a bladder with more than two inflatable chambers and an integral control flap, which are integrated into one piece. The bladder is connected to a gas supply which has a sufficient supply of gas to initiate inflation of the chambers of the bladder. The control flap has passages in communication with the chambers and valving for selectively controlling the inflation of the chambers. The valving includes pinch valves that pinch passages in the control flap to selectively inflate or deflate the chamber. Further, the bladder has a chamber for cushioning thighs of a seat occupant, a chamber for cushioning buttocks, and a chamber for providing lumbar support.

### SUMMARY OF THE DISCLOSURE

In one aspect of the present disclosure, a seat adjustment system for an operator seat is provided. The seat adjustment system includes a base support and at least two supports which are disposed laterally to the base support. The at least two supports have a plurality of bolsters. The plurality of bolsters are positioned on an inner surface of an operator console. The at least two supports define an operator seating space there between having a fixed maximum capacity. An adjustment module is operatively coupled with the plurality of bolsters. The adjustment module is adapted to selectively inflate the plurality of bolsters for decreasing the operator seating space with respect to the fixed maximum capacity. Further, the adjustment module is adapted to selectively deflate the plurality of bolsters for increasing the operator seating space with respect to the fixed maximum capacity. The adjustment module is adapted to alter a current operator seating capacity with respect to the fixed maximum capacity based on an operator input.

Other features and aspects of this disclosure will be apparent from the following description and the accompanying drawings.

### BRIEF DESCRIPTION OF THE DRAWINGS

FIG. 1 is a perspective view of an exemplary machine having an operator cabin, in accordance with the concepts of the present disclosure;

FIG. 2 is a perspective view of an operator seat mounted in the operator cabin of the machine of FIG. 1, in accordance with the concepts of the present disclosure;

FIG. 3 is a block diagram of a seat adjustment system for the operator seat, in accordance with the concepts of the present disclosure;

FIG. 4 is a perspective view of the operator seat showing an inflation of bolsters, in accordance with an embodiment of the present disclosure; and

FIG. 5 is a perspective view of the operator seat showing a deflation of the bolsters, in accordance with another embodiment of the present disclosure.

### DETAILED DESCRIPTION

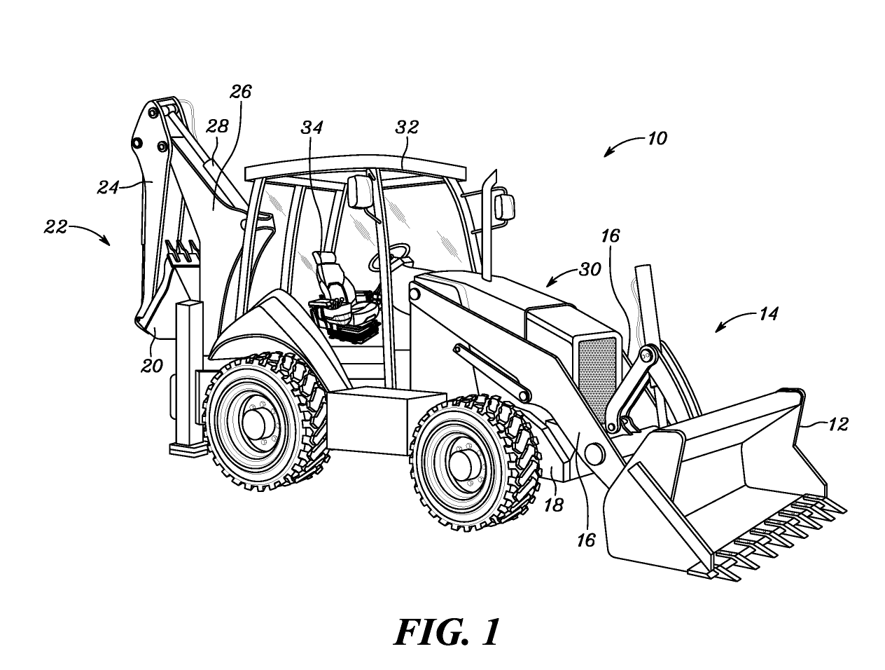

Referring to FIG. 1, an exemplary machine 10 is illustrated. The machine 10 is used for various operations such as, but not limited to, excavation, or digging operations. The machine 10 includes a loader bucket 12 that is disposed at a first end 14 of the machine 10. The loader bucket 12 is coupled to a pair of loader arms 16. The pair of loader arms 16 is further coupled to a frame 18. Further, the machine 10 includes a backhoe bucket 20 which is disposed at a second end 22 of the machine 10. The backhoe bucket 20 is coupled to an arm 24. The arm 24 is further coupled to a boom 26 via a hydraulic cylinder 28.

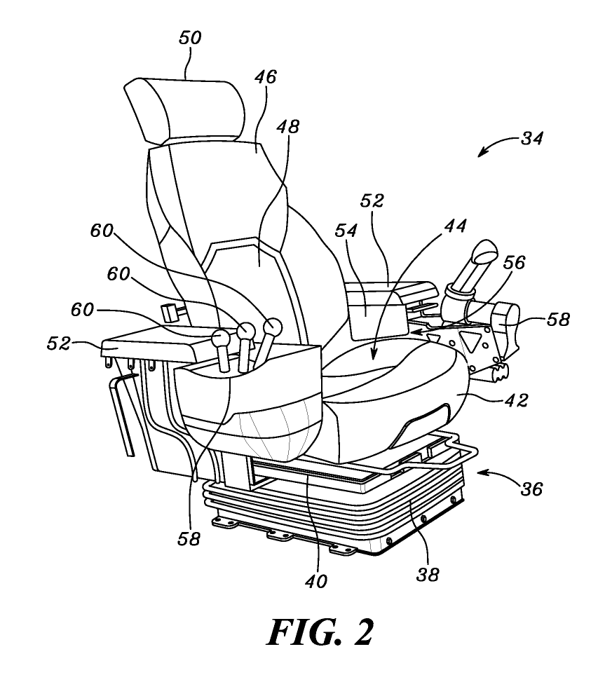

The machine 10 further includes an engine assembly 30 which is disposed at the first end 14 of the machine 10. The engine assembly 30 includes an engine (not shown) that is configured to provide power to the machine 10. Further, the machine 10 includes an operator cabin 32 having multiple controls for operating the machine 10. The operator cabin 32 includes an operator seat 34 in which an operator sits and operates the machine 10. The detailed description of the operator seat 34 is described later in conjunction with FIG. 2. The machine 10 further includes various other components such as, but not limited to, hydraulic cylinders, or wheels, that are not labeled in FIG. 1 for the purpose of simplicity. It will be apparent to one skilled in the art that the machine 10 shown in FIG. 1 is a backhoe loader. However, the machine 10 may be any other machine such as, but not limited to, a track-type tractor, a hydraulic mining shovel, or an excavator, without departing from the scope of the disclosure.

Referring to FIG. 2, the operator seat 34 includes a support assembly 36 having a support member 38. The support member 38 is adapted to dampen vibrations transmitted from the machine 10 to the operator seat 34. Further, the support assembly 36 includes a seat frame 40 which is coupled to the support member 38. It should be noted that the support member 38 may include a suspension system (not shown) for absorbing vibrations imparted to the operator seat 34. The suspension system may include, but not limited to, springs, or bellows. The support assembly 36 may include a lever (not shown) which is configured to adjust a height of the operator seat 34 such that the operator seated on the operator seat 34 may have an optimum visibility of surrounding area of the machine 10 at a worksite (not shown).

Further, the operator seat 34 includes a base support 42 which is coupled to the seat frame 40 via various techniques such as, but not limited to, welding, adhesives, or fasteners. The base support 42 includes a surface 44 which may include suitable contours and depressions to provide comfort to the operator, and to enhance efficiency of the operator. It should be noted that the base support 42 may include base bolsters (not shown) and a pair of bolster bladders (not shown). The bolster bladders may be disposed within each of the base bolsters to hold a volume of pressurized air. Further, a shape of the base bolsters may be varied depending on the volume of the pressurized air within the bolster bladders.

The operator seat 34 further includes a back portion 46 which is coupled to the base support 42. It should be noted that the back portion 46 may be movable with respect to the base support 42. The back portion 46 includes a support member 48 which is configured to support a back of the operator. The support member 48 corresponds to a lumbar support member. Alternatively, the back portion 46 may include a lumbar bladder (not shown) which is disposed within the support member 48. The lumbar bladder is configured to hold the volume of pressurized air. It should be noted that the back portion 46 may include a pair of back bolsters (not shown) having a pair of bolster bladders (not shown) which are configured to hold a volume of pressurized air. The operator seat 34 further includes a headrest 50 which is coupled atop of the back portion 46 of the operator seat 34. The headrest 50 is configured to support a head of the operator.

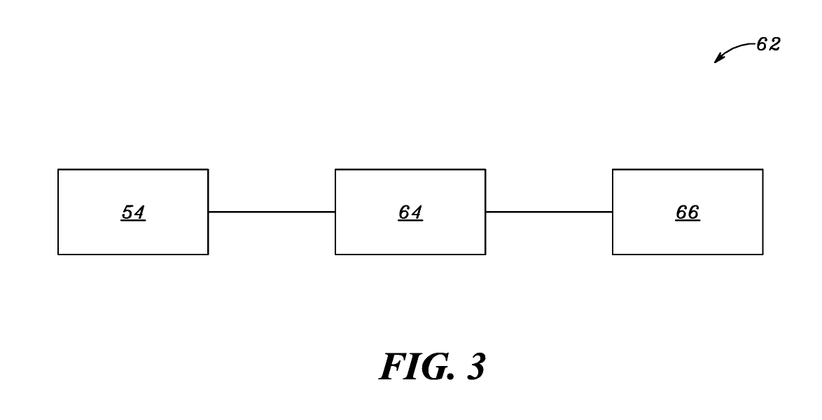

Further, the operator seat 34 includes at least two supports 52 which are disposed laterally to the base support 42. The supports 52 are adapted to define an operator seating space between the supports 52 and define a fixed maximum capacity. It should be noted that the fixed maximum capacity corresponds to a maximum volume (i.e. the capacity) between the supports 52 that the operator seat 34 has in order to accommodate a wide range of operator sizes. The supports 52 include a number of bolsters 54 which are positioned on an inner surface 56 of an operator console 58. It should be noted that the bolsters 54 are positioned within the inner surface 56 of the operator console 58. The detailed description of the bolsters 54 are described later in conjunction with FIG. 3. The operator console 58 includes a number of joysticks 60. Alternatively, the joysticks 60 may be replaced by switches, control buttons, and so on for manual controlling of the operations of the machine 10 by the operator. It should be noted that the joysticks 60 may include a directional controller (not shown) to steer the machine 10 in a direction of travel, without departing from the scope of the disclosure.

Referring to FIG. 3, a seat adjustment system 62 for the operator seat 34 is illustrated. The seat adjustment system 62 includes an adjustment module 64 which is operatively coupled with the bolsters 54. As discussed above, the bolsters 54 are positioned on the inner surface 56 of the operator console 58. It should be noted that the bolsters 54 may include bolster bladders (not shown) within the bolsters 54. The bolster bladders are configured to hold the volume of pressurized air. A shape and structure of the bolster bladders may vary, for example, the bolster bladders may have a flexible walled structure. Alternatively, the bolster bladders may include an air spring. Further, the shape of the bolsters 54 may vary depending on the volume of the pressurized air within the bolster bladders. It should be noted that the bolsters 54 may be made up of materials such as, but not limited to, fabric or leather, without departing from the scope of the disclosure.

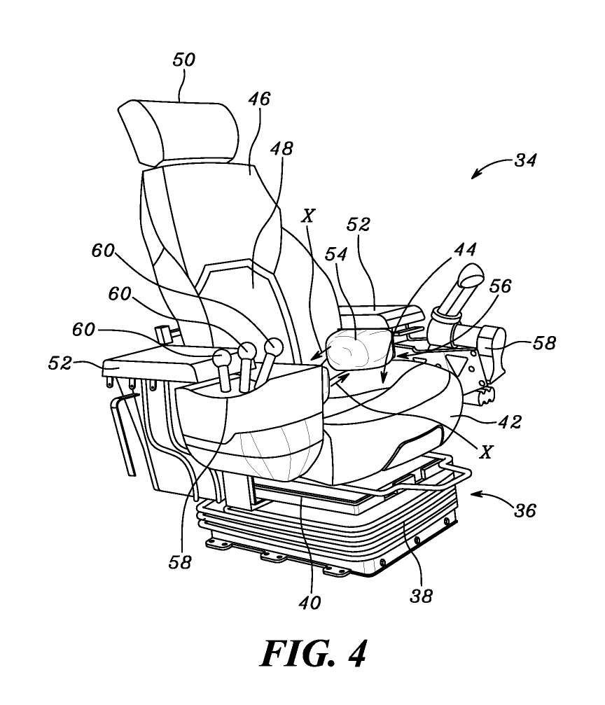

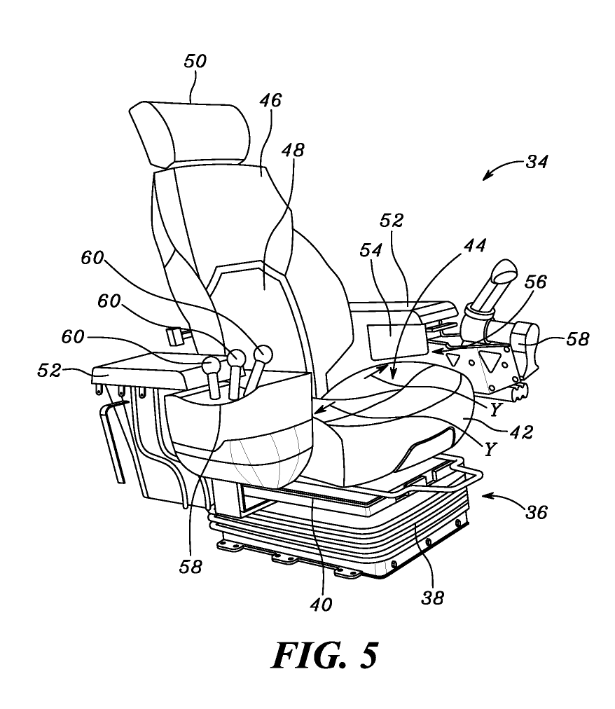

The adjustment module 64 is further coupled to an operator input interface 66. The operator input interface 66 is operated by the operator to activate or deactivate the seat adjustment system 62. The operator input interface 66 may include, but not limited to, a button or a switch on a control panel (not shown). The operator provides an input to the adjustment module 64. The operator input triggers the adjustment module 64 to inflate the bolsters 54 for decreasing the operator seating space or deflate the bolsters 54 for increasing the operator seating space. As an example, the operator may provide the operator input by manually pressing a switch (not shown) which may be disposed on the operator console 58 or any other suitable position. Based on the operator input, the adjustment module 64 is adapted to adjust the operator seating space with respect to the fixed maximum capacity of the operator seat 34. It should be noted that the adjustment module 64 may include a compressor (not shown) for inflating the bolsters 54 and a valve (not shown) for deflating the bolsters 54. The detailed description of the inflation and the deflation of the bolsters 54 is described later in conjunction with FIGS. 4 and 5.

Referring to FIGS. 3 and 4, the adjustment module 64 is adapted to alter a current operator seating capacity with respect to the fixed maximum capacity based on the operator input. It should be noted that the adjustment module 64 adjusts the operator seating space according to the size of the operator. As shown in FIG. 4, in a scenario, if relatively lesser seating space is required by the operator, then the operator may provide the operator input by manually operating the switch to adjust the operator seat 34. Based on the operator input, the adjustment module 64 activates the compressor to inflate the bolsters 54 as shown in a direction X, for decreasing the operator seating space with respect to the fixed maximum capacity, and thus results in reducing the operator seating space between the supports 52.

Referring to FIG. 5, in another scenario, if the operator requires relatively more seating space, then the operator may provide the operator input by operating the switch to adjust the operator seat 34. Based on the operator input, the adjustment module 64 (see FIG. 3) actuates the valve to deflate the bolsters 54 as shown in a direction Y, for increasing the operator seating space with respect to the fixed maximum capacity, and thus results in widening the operator seating space between the supports 52. The above mentioned scenarios for the inflation and the deflation of the bolsters 54 have been provided only for explanation purposes, without departing from the scope of the disclosure.

It will be apparent to one skilled in the art that the operator seat 34 may be used in various other machines such as, but not limited to, dump trucks, haul trucks, or off highway trucks. Alternatively, the operator seat 34 may also be used to provide a simulating environment of a real time operation of the machine 10. Further, the operator seat 34 may include a temperature control unit (not shown). The temperature control unit may be configured to cool or warm the operator seat 34 based on the operator input, without departing from the scope of the disclosure. The seat adjustment system 62 mentioned above may be operated in an automatic mode as well, without departing from the scope of the disclosure. In the automatic mode, the operator seating space is adjusted automatically (without any manual intervention) by controlling the inflation and the deflation of the bolsters 54 in order to accommodate a wide range of operator sizes.

### INDUSTRIAL APPLICABILITY

The present disclosure provides the seat adjustment system 62 for the operator seat 34. The seat adjustment system 62 includes the bolsters 54 which are positioned on the inner surface 56 of the operator console 58 for adjusting the operator seating space. Further, the seat adjustment system 62 includes the adjustment module 64 for altering the operator seating space based on the operator input that allows the operator to manually control the inflation and the deflation of the bolsters 54. Further, the seat adjustment system 62 is adapted to selectively inflate the bolsters 54 for decreasing the operator seating space with respect to the fixed maximum capacity, so that the operator may maintain the optimal position in the operator seat 34. Also, the seat adjustment system 62 may prevent the operator from moving from one side to another other in the operator seat 34 as the machine 10 moves on a variety of terrains such as grades, or side slopes by providing a tailored seating space as per the size of the operator seated in the operator seat 34.

The seat adjustment system 62 is further adapted to selectively deflate the bolsters 54 for increasing the operator seating space with respect to the fixed maximum capacity, to appropriately accommodate the operator. Therefore, the seat adjustment system 62 is an effective, retrofittable, easy to implement, and accurate solution for altering the operator seating space for the operator seat 34.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A seat adjustment system for an operator seat, the seat adjustment system comprising:
a base support;
at least two supports disposed laterally to the base support, the at least two supports having a plurality of bolsters, the plurality of bolsters positioned on an inner surface of an operator console, wherein the at least two supports define an operator seating space therebetween having a fixed maximum capacity; and
an adjustment module operatively coupled with the plurality of bolsters, the adjustment module adapted to:
selectively inflate the plurality of bolsters for decreasing the operator seating space with respect to the fixed maximum capacity; and
selectively deflate the plurality of bolsters for increasing the operator seating space with respect to the fixed maximum capacity,
wherein the adjustment module is adapted to alter a current operator seating capacity with respect to the fixed maximum capacity based on an operator input.
